(19) United States
(12) Patent Application Publication
(10) Pub. No.: US 2015/0150148 A1
(43) Pub. Date: May 28, 2015

(54) CONFIGURING AND CONTROLLING DIGITAL ECOSYSTEM OF DEVICES, USER PROFILES, AND CONTENT

(71) Applicant: SONY CORPORATION, Tokyo (JP)

(72) Inventor: JASON MICHAEL WARNER, San Diego, CA (US)

(73) Assignee: SONY CORPORATION, Tokyo (JP)

(21) Appl. No.: 14/092,166

(22) Filed: Nov. 27, 2013

(51) Int. Cl. H04L 29/06; H04L 29/08

(52) U.S. Cl. CPC H04L 63/10; H04L 67/32
USPC 726/28

(57) ABSTRACT

Systems and methods are disclosed for accessing plural user profiles of respective users associated with an establishment, accessing device information pertaining to plural devices associated with the establishment, accessing content information pertaining to plural media content, receiving a user request for first content, and based at least in part on a first user profile and based at least in part on the content information, determining whether a first user associated with the first user profile is authorized to access the first content. Responsive to a determination that the first user is not authorized to access the first content, the request for first content is denied. Responsive to a determination that the first user is authorized to access the first content, a first device is identified that the first user is authorized to use and that can present the first content.

### FIELD OF THE INVENTION

The present application relates generally to management and presentation of content on consumer electronics (CE) devices.

### BACKGROUND OF THE INVENTION

Devices joining a network such as a home Wi-Fi network may be configured to access content over the network. However, there currently are no adequate ways to, after a device joins the network, manage what content a first user using the device or any other device on the network may access, and/or managing what content and/or information another user of the same device on the network may access if different from what the first user may access using the device.

### SUMMARY OF THE INVENTION

Accordingly, in a first aspect, an apparatus includes at least one computer readable storage medium that is not a carrier wave. The storage medium bears instructions executable by a processor to configure the processor for accessing plural user profiles associated with an establishment, where the user profiles are electronically stored in a single computer and each user profile is associated with a respective user affiliated with the establishment. The instructions also configure the processor for accessing device information stored in the computer pertaining to plural devices in the establishment, accessing content information stored in the computer and pertaining to plural media content, and receiving a user request for first content. Based at least in part on a first user profile associated with the user request, the instructions configure the processor for determining based at least in part on the content information whether a first user associated with the first user profile is authorized to access the first content. Responsive to a determination that the first user is not authorized to access the first content, the instructions configure the processor for denying the request for first content. Responsive to a determination that the first user is authorized to access the first content, the instructions configure the processor for determining, based at least in part on the user profile and/or device information, a first device that the first user is authorized to use and that can present the first content, and returning a control signal indicating that the first user can use the first device to play the first content.

In some embodiments, the control signal may be established at least in part by the processor when executing the instructions by automatically presenting the first content on the first device responsive to the determination that the first user is authorized to access the first content, and/or by automatically presenting a message on the first device that the first device can play the first content for the user. Also in some embodiments, the request for first content may be received from a second device, and the control signal may be established at least in part by the processor when executing the instructions by presenting a message on the second device to use the first device to play the content.

In addition to the foregoing, in some embodiments the establishment may be a dwelling such as e.g. a personal residence, and the processor may be part of the computer. However, in other embodiments the processor may not be part of the computer but may communicate with the computer over a network.

In another aspect, a method includes accessing plural user profiles associated with an establishment where each user profile is associated with a respective user affiliated with the establishment, accessing device information pertaining to plural devices in the establishment, accessing content information pertaining to plural media content, receiving a user request for first content, and based at least in part on a first user profile associated with the user request, determining based at least in part on the content information whether a first user associated with the first user profile is authorized to access the first content. The method then includes denying the request for first content responsive to a determination that the first user is not authorized to access the first content. In addition, the method includes, responsive to a determination that the first user is authorized to access the first content, determining based at least in part on the user profile and/or device information a first device that the first user is authorized to use and that can present the first content, and the method may then include returning a control signal indicating that the first user can use the first device to play the first content.

In still another aspect, a computer system includes a processor and a computer readable medium accessible to the processor and bearing instructions executable by the processor for presenting a user interface (UI) on a display controllable by the processor. The UI includes at least first, second, and third selector elements, where the first selector element is selectable to cause information pertaining to devices configured to communicate on a network to be presented. The second selector element is selectable to cause information pertaining to respective user profiles of plural users to be presented, where the information pertaining to respective user profiles including information for each of the plural users indicates that the user's respective profile is associated with at least one of the devices. The third selector element is selectable to cause information pertaining to audio video (AV) content to be presented, where the information pertaining to AV content includes information for whether at least a first user is authorized to observe AV content of a certain ratings and on which device or devices configured to communicate on the network the first user is authorized to observe AV content of the certain rating.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system including two example CE devices in accordance with present principles;

FIGS. 2 and 3 are exemplary flowcharts of logic to be executed by a CE device in accordance with present principles; and

FIGS. 4-9 are exemplary user interfaces (UIs) presentable on a CE device in accordance with present principles.

### DETAILED DESCRIPTION OF THE PREFERRED EMBODIMENT

This disclosure relates generally to consumer electronics (CE) device based user information. With respect to any computer systems discussed herein, a system herein may include server and/or head end, and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may employ, as non-limiting examples, operating systems from Apple, Google, or Microsoft. A Unix operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software modules described by way of flow charts and/or user interfaces herein can include various sub-routines, procedures, etc. It is to be understood that logic divulged as being executed by a module can be redistributed to other software modules and/or combined together in a single module and or made available in a shareable library.

Logic when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

In an example, a processor can access information over its input lines from data storage, such as the computer readable storage medium, and/or the processor accesses information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the CE device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

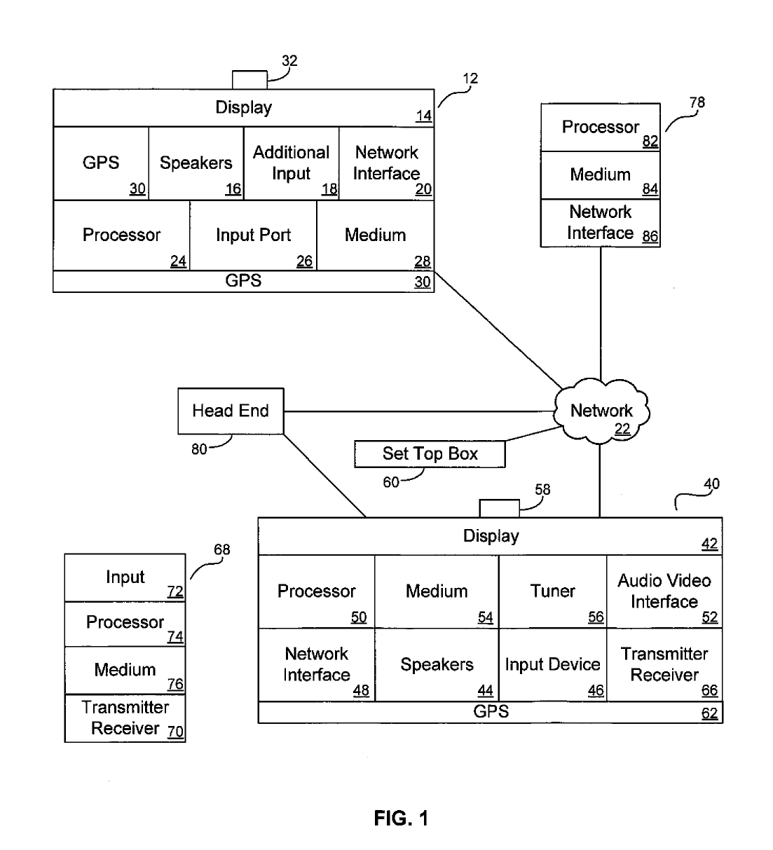

Still before describing FIG. 1, it is to be understood that the CE devices and software described herein are understood to be usable in the context of a digital ecosystem. Thus, as understood herein, a computer ecosystem, or digital ecosystem, may be an adaptive and distributed socio-technical system that is characterized by its sustainability, self-organization, and scalability. Inspired by environmental ecosystems, which consist of biotic and abiotic components that interact through nutrient cycles and energy flows, complete computer ecosystems consist of hardware, software, and services that in some cases may be provided by one company, such as Sony Electronics. The goal of each computer ecosystem is to provide consumers with everything that may be desired, at least in part services and/or software that may be exchanged via a network such as the Internet. Moreover, interconnectedness and sharing among elements of an ecosystem, such as applications within a computing cloud, provides consumers with increased capability to organize and access data and presents itself as the future characteristic of efficient integrative ecosystems.

Two general types of computer ecosystems exist: vertical and horizontal computer ecosystems. In the vertical approach, virtually all aspects of the ecosystem are associated with the same company (e.g. produced by the same manufacturer), and are specifically designed to seamlessly interact with one another. Horizontal ecosystems, one the other hand, integrate aspects such as hardware and software that are created by differing entities into one unified ecosystem. The horizontal approach allows for greater variety of input from consumers and manufactures, increasing the capacity for novel innovations and adaptations to changing demands. But regardless, it is to be understood that some digital ecosystems, including those referenced herein, may embody characteristics of both the horizontal and vertical ecosystems described above.

Now specifically referring to FIG. 1, an example system 10 is shown, which may include one or more of the example devices disclosed herein and described further below to present information such as e.g. aggregated device, content, and/or user profile information in accordance with present principles. The first of the example devices included in the system 10 is an example consumer electronics (CE) device 12. The CE device 12 may be, e.g., a computerized Internet enabled (“smart”) telephone, a tablet computer, a notebook computer, a wearable computerized device such as e.g. computerized Internet-enabled watch, a computerized Internet-enabled music player, and even e.g. a computerized Internet-enabled television (TV). Regardless, it is to be understood that the CE device 12 is configured to undertake present principles (e.g. to communicate with other CE devices to undertake present principles, to execute the logic described herein, and perform any other functions and/or operations described herein).

Accordingly, to undertake such principles the CE device 12 may include some or all of the components shown in FIG. 1. For example, the CE device 12 can include one or more touch-enabled displays 14 (e.g. configured to receive input such touch-input from a user, present images thereon including the user interfaces (UIs) described below, etc.), one or more speakers 16 for outputting audio, and at least one additional input device 18 such as e.g. an audio receiver/microphone for e.g. entering audible commands to the CE device 12 to control the CE device 12. The example CE device 12 may also include one or more network interfaces 20 for communication over at least one network 22 such as the Internet, an WAN, an LAN, etc. under control of one or more processors 24. It is to be understood that the processor 24 controls the CE device 12 to undertake present principles, including the other elements of the CE device 12 described herein such as e.g. controlling the display 14 to present images/content thereon and receiving input therefrom. Furthermore, note the network interface 20 may be, e.g., a wired or wireless modem or router, or other appropriate interface such as, e.g., a wireless telephony transceiver, Wi-Fi transceiver, etc.

In addition to the foregoing, the CE device 12 may also include one or more input ports 26 such as, e.g., a USB port to physically connect (e.g. using a wired connection) to another CE device. The CE device 12 may further include one or more tangible computer readable storage mediums 28 such as disk-based or solid state storage, it being understood that the computer readable storage medium 28 may not be a carrier wave. Also in some embodiments, the CE device 12 can include a position or location receiver such as but not limited to a GPS receiver 30 that is configured to e.g. receive geographic position information from at least one satellite and provide the information to the processor 24. However, it is to be understood that another suitable position receiver other than a GPS receiver may be used in accordance with present principles to e.g. determine the location of the CE device 12.

Continuing the description of the CE device 12, in some embodiments the CE device 12 may include one or more cameras 32 that may be, e.g., a thermal imaging camera, a digital camera such as a webcam, and/or a camera integrated into the CE device 12 and controllable by the processor 24 to gather pictures/images and/or video in accordance with present principles (e.g. to gather an image of a user of the CE device for facial recognition purposes).

Still referring to FIG. 1, in addition to the CE device 12, the system 10 may further include at least one more CE device such as a CE device 40 that in exemplary embodiments may be a television (TV) such as e.g. a high definition TV and/or Internet-enabled computerized TV (e.g. a “smart” TV). It is to be understood that the CE device 40 is also configured to undertake present principles.

Describing the CE device 40 with more specificity, it includes one or more touch-enabled displays 42, one or more speakers 44 for outputting audio in accordance with present principles, and at least one additional input device 46 such as e.g. an audio receiver/microphone for e.g. entering audible commands to the CE device 40 to control the CE device 40. The CE device 40 may also include one or more network interfaces 48 for communication the network 22 under control of one or more processors 50. It is to be understood that the processor 50 controls the CE device 40 to undertake present principles, including the other elements of the CE device 40 described herein such as e.g. controlling the display 42 to present images/content thereon and receiving input. Furthermore, note the network interface 48 may be, e.g., a wired or wireless modem or router, or other appropriate interface such as, e.g., a wireless telephony transceiver, Wi-Fi transceiver, etc.

In addition to the foregoing, the CE device 40 may also include e.g. an audio video (AV) interface 52 such as, e.g., a USB or HDMI port for receiving input (e.g. AV content) from a component device such as e.g. a set top box 60 or Blue Ray disc player for presentation of the content on the CE device 40, as well as a tuner 56 also configured for receiving input. The CE device 12 may further include one or more tangible computer readable storage mediums 54 such as disk-based or solid state storage, it being understood that the computer readable storage medium 54 may not be a carrier wave. Also in some embodiments, the CE device 40 can include a position or location receiver such as but not limited to a GPS receiver 62 that is configured to e.g. receive geographic position information from at least one satellite and provide the information to the processor 50. However, it is to be understood that another suitable position receiver other than a GPS receiver may be used in accordance with present principles to e.g. determine the location of the CE device 40.

Continuing the description of the CE device 40, in some embodiments the CE device 40 may include one or more cameras 58 that may be, e.g., a thermal imaging camera, a digital camera such as a webcam, and/or a camera integrated into the CE device 40 and controllable by the processor 50 to gather pictures/images and/or video in accordance with present principles (e.g. to gather an image of a user of the CE device for facial recognition purposes). In addition to the foregoing, the CE device 40 may also include a transmitter/receiver 66 for communicating with a remote commander (RC) 68 associated with the CE device 40 and configured to provide input (e.g., commands) to the CE device 40 (e.g. to the processor 50) to thus control the CE device 40, and to also provide input to the set top box 60 to control it as well.

Accordingly, the RC 68 also has a transmitter/receiver 70 for communicating with the CE device 40 through the transmitter/receiver 66, and/or for communicating with the set top box 60 through a respective transmitter (not shown) associated with the set top box 60. The RC 68 also includes an input device 72 such as a keypad or touch screen display, as well as a processor 74 for controlling the RC 68 and a tangible computer readable storage medium 76 such as disk-based or solid state storage. Though not shown, in some embodiments the RC 68 may also include a touch-enabled display screen and a microphone that may be used for providing input/commands to the CE device 40 in accordance with present principles.

Still describing FIG. 1, it also shows at least one server 78 configured for communication with the CE devices 12, 40, and also a head end 80 to be described shortly. The server 78 includes at least one processor 82, at least one tangible computer readable storage medium 84 that may not be a carrier wave such as disk-based or solid state storage, and at least one network interface 86 that, under control of the processor 82, allows for communication with the CE devices of FIG. 1 over the network 22, and indeed may facilitate communication therebetween in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 78 may be an Internet server, and may store and/or provide information and data to one of the CE devices 12, 40 in accordance with present principles. Note that in example embodiments the server 78 may include and perform “cloud” functions such that the CE devices 12, 40 of the system 10 may access a “cloud” environment (e.g., where at least some of the information and logic described herein may be stored) via the server 78 to e.g. access information stored thereat, stream music for which to listen and/or stream or download audio video (AV) content to the CE device.

Now in reference to the afore-mentioned head end 80, it is to be understood that in example embodiments the head end 80 may be e.g. a cable head end and/or a satellite head end. The head end 80 is understood to be in communication with the CE device 40, and/or even the CE device 12 and server 78 over, e.g., a closed network (through a wired or wireless connection), and furthermore may itself include a network interface (not shown) such that the head end 80 may communicate with the CE devices 12, 40 and/or server 78 over a wide-area and/or open network such as the network 22. Further still, it is to be understood that the head end 80 may be wired or wirelessly connected to a non-internet server, and/or may optionally be integrated with a non-internet server or the server 78. In any case, it is to be understood that the head end 80 may facilitate the transmission of information and AV content to the CE device 40 through e.g. the set top box 60 in accordance with present principles. It is to be understood that the set top box 60 may e.g. locally store (on a computer readable storage medium not shown) a channel and/or program history of AV content that has been selected at the set top box 60 for presentation on the CE device 40 under control of a set top box processor (also not shown). Notwithstanding, it is to be understood that e.g. the sever 78 and head end 80 may also store channel and/or program history information to provide it to a CE device in accordance with present principles (e.g. recommending content).

It is to be understood that other CE devices described herein may each respectively include some or all of the various components described above in reference to the CE devices 12, 40 even if not specifically shown or described.

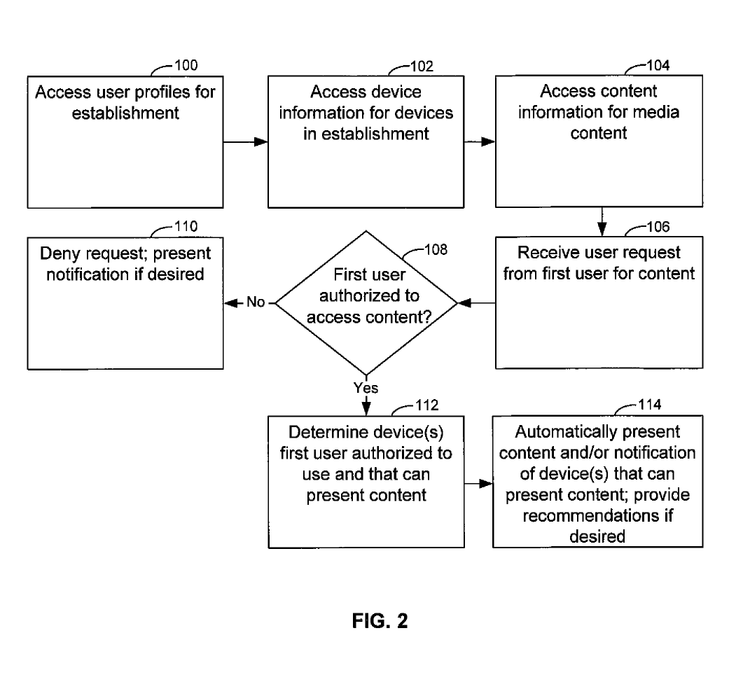

Now in reference to FIG. 2, a flow chart of example logic to be executed by a CE device in accordance with present principles is shown. Beginning at block 100, the logic accesses one or more user profiles and/or profile information associated with an establishment such as e.g. a personal residence having a Wi-Fi network and (e.g. registered) user profiles associated therewith. It is to be understood that each profile may be associated with a particular user, although present principles recognize that a profile for a group of users may be used as well. It is to be further understood that in some embodiments, the profiles and/or profile information that are accessed at block 100 may be electronically stored in a single computer (e.g. a storage medium associated therewith) or otherwise at a single location.

After block 100, the logic proceeds to block 102 where the logic accesses device information for one or more devices associated with and/or currently located in the establishment (e.g. as determined based on GPS coordinates and/or the device communicating (e.g. the GPS coordinates) over the network). It is to be understood that in some embodiments, the device information accessed at block 102 may be electronically stored in the same single computer as stores the profile and/or profile information.

The logic then moves from block 102 to block 104, where the logic accesses content information for one or more pieces of content such as e.g. audio video (AV) content, video only content, audio only content, still images, etc. In some embodiments, the content information accessed at block 104 may also be electronically stored in the same single computer as stores the profile and/or profile information and/or device information. Note that this computer in exemplary embodiments may store the information accessed at blocks 100, 102, and 104, may be the computer undertaking the present logic, or may be a computer accessible to another CE device where the other CE device undertakes the present logic.

In any case, after block 104 the logic proceeds to block 106 where the logic receives a request from a user to present a particular piece of content (referred to as a “first piece of content” when describing the logic of FIG. 2) on a specified device. Note that the request may be from a device on which the user desires the content presented and hence the request may specify that device as the device on which to present the first piece of content, and/or can be from another device with the user specifying in the request the other device on which the content the first piece of content should be presented. Note further that the request is understood to include identifying information (e.g. login information, and/or an image of the user for facial recognition purposes) for the user submitting the request so that e.g. the processor undertaking the logic of FIG. 2 may determine a profile associated with the user, whether the user is authorized to view the content, and/or on which device(s) the user is authorize to observe content, all in accordance with present principles.

Thus, it is to be understood that the user may provide input such as e.g. a login and password along with the request (and/or included in the request) for accessing the content and/or accessing the network on which the devices are communicating in accordance with present principles. However, in addition to or in lieu of the foregoing, other methods of identifying, determining, and/or verifying the user may be employed, such as e.g. facial recognition technology using an image of the user gathered by a camera on the CE device from which the request was input, based on thumb print technology using a thumb print of a user collected e.g. by a touch-enabled display screen of the CE device from which the request was input, and/or using other biometric identifying technologies.

Still in reference to FIG. 2, from block 106 the logic proceeds to decision diamond 108, at which the logic determines whether the user that provided the request received at block 106 is a user authorized to access and/or observe the first content. The determination may be made based at least in part on the content information, as well as the user's profile information e.g. as accessed at block 100 and/or that is associated with the user even if not accessed at block 100 but as determined based on e.g. facial recognition as set forth above. In any case, responsive to a determination at diamond 108 that the first user is not authorized to access the requested first content, the logic proceeds to block 110 where the logic denies the user's request by e.g. not providing the content as requested (e.g. not providing it on a requested or default CE device associated with the user) and/or by presenting a prompt, message, and/or user interface (UI) indicating the user's request has been denied. However, responsive to a determination at diamond 108 that the first user is authorized to access the first content, the logic instead moves to block 112. At block 112, the logic determines a first device that the first user is authorized to use and that can present the first content. The determination at block 112 may be made e.g. based at least in part on the user profile and/or device information, and/or other settings as discussed further below.

After block 112, the logic may conclude at block 114 where the logic provides an indication that the first user can use one or more devices to present the requested content. The indication may include e.g. automatically presenting the requested content on a requested or default CE device for the user, and/or automatically presenting the requested content on the device which the user used to input the request received at block 106, and/or automatically presenting the requested content on another device connected to the network of the establishment and e.g. specified in the request. In addition to or in lieu of the foregoing, the indication may be provided e.g. in the form of a prompt, message, and/or UI presented on the device from which the request was provided or another device that indicates the user's request has been denied. Still further, in addition to or in lieu of the foregoing, the indication may be provided in the form of a prompt, message, and/or UI presented on the device from which the user provided the request that indicates another device should be used for observing the content that is e.g. connected to the network of the establishment.

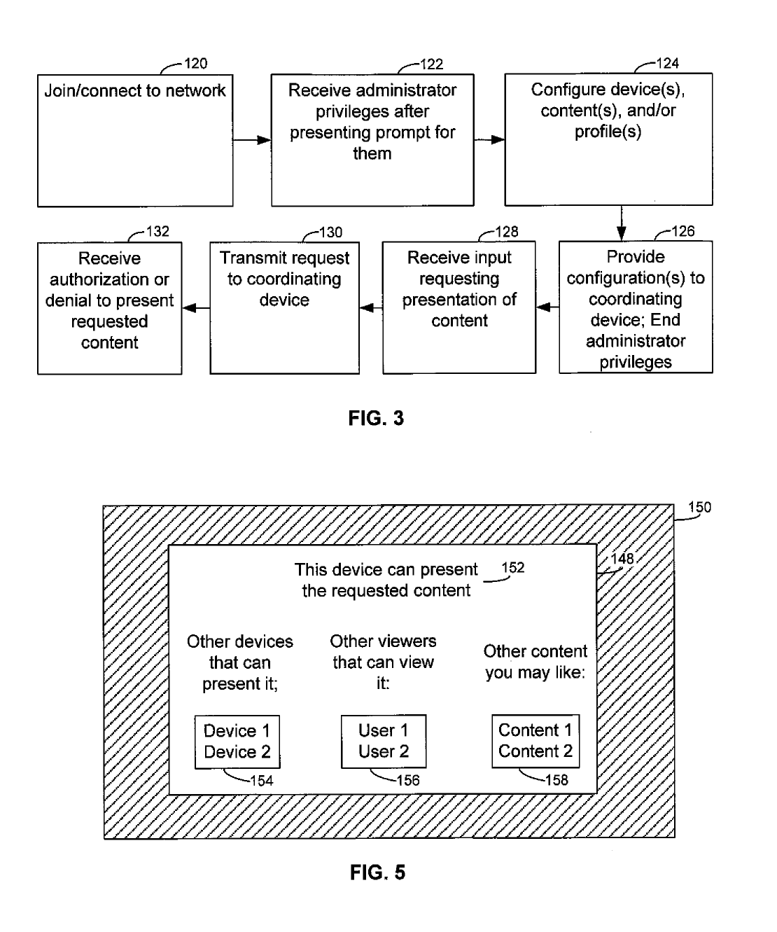

Continuing the detailed description in reference to FIG. 3, another exemplary flow chart of logic to be executed by a CE device in accordance with present principles is shown, the flow chart of FIG. 3 being for e.g. initially joining a network and configuring a CE device to undertake present principles. Beginning at block 120, the logic joins a network for e.g. a personal dwelling or residence in accordance with present principles such as a Wi-Fi network and/or LAN. The logic then moves to block 122 where the logic presents a prompt requesting input of administrator privileges and/or authentication information to authorize the device to join the network and/or to configure the CE device for undertaking present principles. The logic then proceeds to block 124 where the logic configures (e.g. based on user input such as from e.g. an administrator of the network) the CE device joining the network and/or a user profile for a user to be associated with the CE device (e.g. if the user of the joining device has previously not been associated with a profile).

After block 124 the logic moves to block 126 where the logic provides the device and/or profile information configured at block 124 to one or more CE devices connected to the network, including e.g. a central, coordinating CE device (e.g. a CE device acting as a server, though it is to be understood that a server may also be used) that may store all device information, user profiles and/or profile information, and/or content and/or content information. Also at block 126 the logic ends the administrator session or otherwise ends the administrator privileges that have been granted to the CE device. Thereafter, the logic moves to block 128 where the logic receives input from a user requesting presentation of e.g. AV content. Responsive thereto, the logic at block 130 may transmit a request to the coordinating CE device for the AV content for which input was received at block 128. Then at block 132 the logic receives from the coordinating device an authorization or denial to present the requested content based on e.g. user profile permissions, device capabilities, the rating of the AV content, etc. in accordance with present principles.

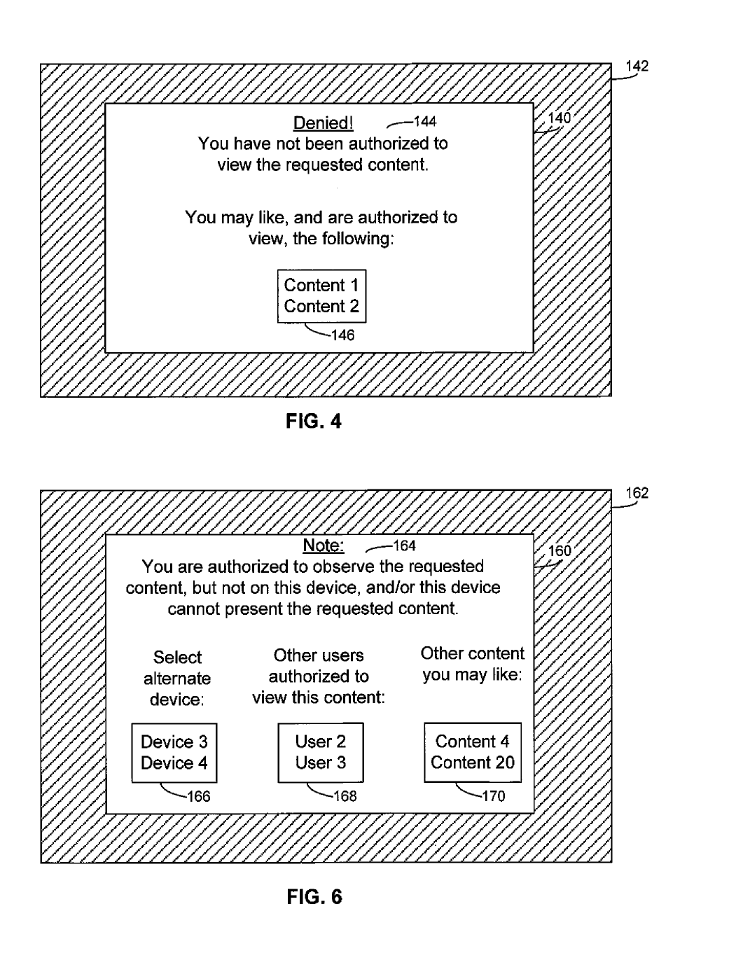

An example of a denial message that may be received at block 132 is shown in FIG. 4 as message 140. As may be appreciated from FIG. 4, the denial message 140 may be e.g. overlaid on content being presented on a CE device display 142. The message may contain a bolded heading 144 such as “Denied!” and may indicate beneath the heading 144 that the user (e.g. as determined based on profile information associated with the user) is not authorized to observe the content, and/or that the CE device on which the message 140 is presented is not authorized to have the requested content presented thereon. Note, however, that the CE device (based on e.g. information from a coordinating CE device in accordance with present principles) may also present a box 146 of one or more recommended pieces of content that are presentable on the CE device based on e.g. determinations at the coordinating device and/or the presently referenced CE device that the user's profile and/or the device are configured for and permitted to present the contents provided in the box 146. Note further that the content indications as listed in the box 146 may thus each be selectable to automatically without further user input responsive thereto present the underlying content associated therewith on the present CE device.

In contrast to FIG. 4, FIG. 5 shows a message 148 that may be presented on a CE device display 150 in accordance with present principles when the user of the device (e.g. based on an associated user profile) and/or the device itself has been authorized to observe or present the requested content. The e.g. overlaid message 148 may contain a bolded heading 152 that the CE device can and/or will present the requested content. The message 148 may also indicate other devices on the network that are available to present the requested content (e.g. based on profile information, device information, etc.) and include a box 154 associated therewith listing the devices, where each of the device indications in the list may be selectable to automatically without further user input responsive thereto present the requested underlying content on the CE device associated with the selected indication.

Still in reference to FIG. 5, in some embodiments the message 148 may also contain an indication that other users have been authorized to observe the content, and thus a box 156 may be included in the message 148. The box 156 may include indications of other users that are so authorized, and each of the indications may be selectable to automatically without further user input responsive thereto present the content on at least one device associated with the selected user in addition to presenting the content on the present CE device.

Also in some embodiments, the message 148 may contain indications of other (e.g. recommended) contents that are available for presentation on the present CE device (e.g. based on user profile settings, device capabilities, etc.), and thus a box 158 may be presented on the message 148. The box 158 may include indications of the other available contents, and each of the indications may be selectable to automatically without further user input responsive thereto present the alternate/other content selected from the box 158 on the present CE device.

In contrast to both FIGS. 4 and 5, FIG. 6 shows a message 160 that may be presented on a CE device display 162 in accordance with present principles when the user of the device (e.g. based on an associated user profile) has been authorized to observe the requested content but when the content cannot be presented on the present CE device (e.g. the device presenting the message 160). The e.g. overlaid message 160 may thus contain an indication 164 that the user (e.g. based on a profile associated with the user) is authorized to observe the requested content, but that either or both the user has not been authorized to observe the content on the particular presently described CE device and/or the present CE device cannot present the requested content (e.g. owing to limitations of the present CE device such as its inability to present HD content, wide screen content, connection speed with which it may stream the content from a coordinating device, etc.).

Thus, beneath the indication 164 are boxes 166, 168, and 170. The box 166 may include indications of other networked CE devices on which the content may be presented, it being understood that each of the indications in the box 166 are respectively selectable to automatically without further user input responsive thereto cause the requested content to be presented on the underlying CE device associated with the indication selected using the box 166. The box 168 may include indications of other users that are authorized to observe the content, and each of the indications in the box 168 may thus be selectable to automatically without further user input responsive thereto present the content on at least one device associated with the underlying user associated with the indication selected form the box 168 (e.g., in addition to presenting the content on the present CE device). The box 170 may contain indications of other (e.g. recommended) contents that are available for presentation on the present CE device (e.g. based on user profile settings, device capabilities, etc.) should the user e.g. wish to nonetheless observe other content on the present CE device if the requested content cannot be presented, and thus the indications of the other available contents are each respectively selectable to automatically without further user input responsive thereto present the underlying alternate/other content associated with the indication selected from the box 170 on the present CE device.

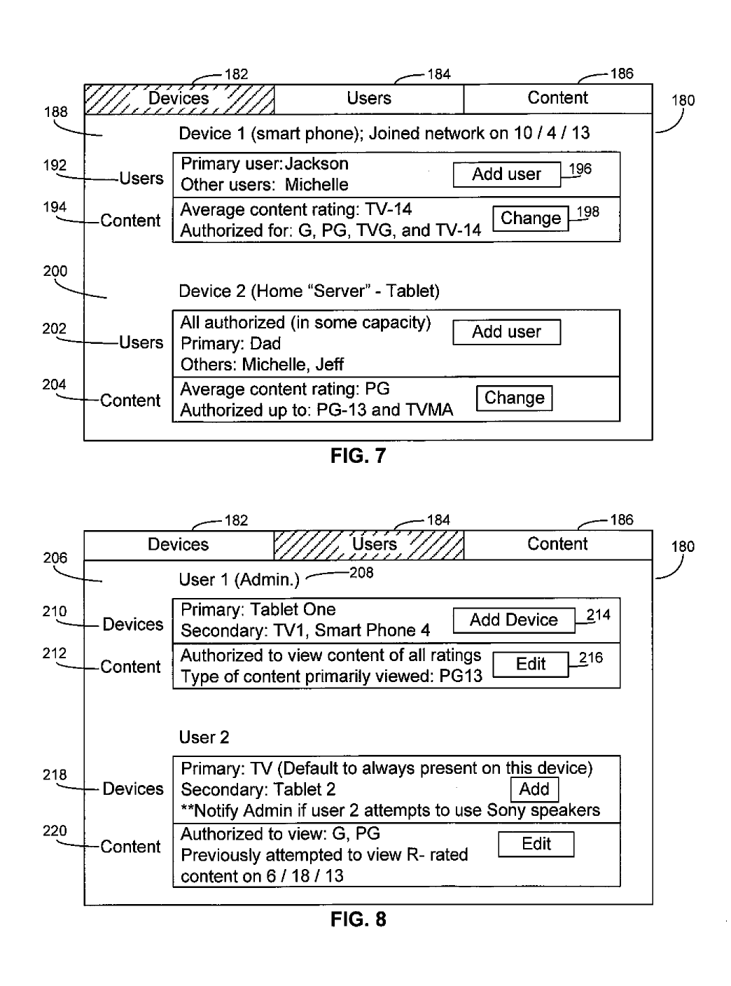

Moving on in the detailed description in reference to FIG. 7, an example UI 180 presenting device, user, and/or content information in accordance with present principles and presentable on a CE device such as a coordinating CE device in accordance with present principles is shown. As may be appreciated from FIG. 7, the UI 180 may include at least first, second, and third tabs 182, 184, and 186 associated with information for devices, users, and content, respectively.

The first tab 182 is selectable to cause information pertaining to devices configured to communicate on an establishment's network to be presented, and indeed as shown in FIG. 7 the information is organized by device in an information portion 188 of the UI 180. The portion 188 thus includes a heading 190 for a first device (labeled “Device 1”), with the heading 190 indicating the device type for the device (e.g. a smart phone in the present instance), along with an indication of when the first device first joined the establishment's network. Beneath the heading 190 is user information 192 for the first device and content information 194 for the first device.

Beginning first with the user information 192, the information 192 may include e.g. an indication of the primary user of the first device and/or default user (e.g. as established by a network administrator in accordance with present principles), as well as indications of other users whom are authorized to observe content on the first device and/or have previously used the first device to observe content. Note that the CE device presenting the UT 180 may e.g. access a history of content viewed on the first device to determine users that have previously used the first device to observe content. In any case, the information 192 also have a selector element 196 associated therewith that is selectable to e.g. automatically without further user input responsive thereto cause another UI and/or overlay window to be presented that is manipulable by a user to add or delete a profile from the information 192 and hence authorize or de-authorize a user associated with the profile from observing content on the first device.

Now describing the content information 194, the information 194 may include e.g. an average content rating for contents previously presented on the first device (e.g. based on a content presentation history for the first device). The content information 194 may also include an indication of authorized ratings for content presentable on the first device. As may be appreciated from the exemplary information 194, content with ratings of G, PG, and TV14 have been authorized for presentation on the first device, but not e.g. content with ratings of R, NC17, or TV-MA. In any case, a selector element 198 is presented on the UI 180 with the information 194 for selection to e.g. change the authorized content ratings for the first device, and/or specifically excluding any content with a particular rating from being presented on the device.

Another information portion 200 is shown on the UI 180 (when e.g. the device tab 182 has been selected as the operative tab) for a second device indicated in the portion 200 as being a “server” for the residence in which it is disposed in that it may actually be a server and/or may be a coordinating CE device acting as a server. Regardless, the portion 200 includes user information 202 for the second device and content information 204 for the second device. Among the information 202 are indications that e.g. all users with profiles (e.g. for which the CE device presenting the UI 180 and/or the coordinating device have access) are authorized to use the second device in some capacity even if not all users have profile configurations authorizing them to use the second device in the same manner such as e.g. viewing content with any rating and/or are changing settings for e.g. the network of devices using the second device. Describing the content information 204, it includes an indication that the second device is authorized to present any content having a rating for e.g. movies of PG-13 and below (e.g. PG or G ratings as well) and television shows or other content of TV-14 rating and below (e.g., not TV-MA).

Reference is now made to FIG. 8, which again shows the UI 180 but this time with the tab 184 being the currently selected and/or operative tab, with a user profile information portion 206 being shown that is understood to pertain to user profiles for users of devices and/or content within the network. Thus, it is to be understood that user profiles in accordance with present principles may be authorized, and hence users associated with respective profiles may be authorized, to view content on one or more CE devices communicating over the network and/or authorized to stream or otherwise acquire a content file and present the content on the CE device over the network.

As shown in FIG. 8, the portion 206 is organized by user profile. As may be appreciated from FIG. 8, the portion 206 includes a heading 208 for a first user profile (labeled “User 1”), with the heading 208 also indicating in the present instance that the user associated with the profile has been granted administrator privileges to e.g. configure user profile, device, and/or content authorizations in accordance with present principles. Beneath the heading 208 is device information 210 for the first user profile and content information 212 for the first user profile.

Describing the device information 210 for the first user profile, it includes an indication of the primary and/or default device associated with the first user profile, which in the present instance is a tablet computer titled (e.g. based on user profile settings for the first user) “Tablet One.” Also included in the information 210 is an indication of other devices for which the first user has been authorized to use and/or has used in the past, and in the present exemplary instance includes a television and smart phone. Note further that the information 210 has a selector element 214 associated therewith that is selectable to e.g. add or remove devices from the profile of User 1 and/or authorize or de-authorize one or more devices associated with the first user profile for presentation of content.

Describing the content information 212 for the first user profile, it includes an indication that the first user through the first user profile is authorized to observe content of all ratings, as well as an indication of the average content rating of contents previously observed by the first user (e.g. as indicated in a viewing history for the user profile). Note that an edit selector element 216 is also shown with the content information 212 and is selectable to e.g. cause an overlay window to be presented on the CE device of FIG. 8 to edit one or more settings of the profile for the first user and even more specifically to edit the first user profile regarding content rating authorizations (e.g. editing AV content rating settings for AV content for which the user associated with the first user profile is authorized to observe).

In addition to presenting information for the first user profile described above, the portion 206 may also present information for a second user profile associated with e.g. a different user than the first user associated with the first user profile. The profile information for the second user includes device information 218 and content information 220. Beginning with the device information 218, it includes an indication of the primary and/or default device associated with the second user profile, which in the present instance is a television. Note further that the indication of the primary device also indicates that the second user profile has been configured to always present content requested by the second user on the television e.g. regardless of whether the request was input by the second user at the TV or another device on the network (e.g. but absent input from the second user (e.g. for a specific request) indicating another device should be used instead).

As may be appreciated from FIG. 8, the information 218 also includes an indication that the second user profile has been configured for one or more (e.g. network) administrators to be notified if the second user attempts using the second user profile to use a particular set of speakers connected to the network. This may be presented responsive to e.g. a setting input by an administrator for the second user profile that limits or denies access to the particular set of speakers by the second user when accesses is attempted using the second user profile, and even e.g. a setting for notifying an administrator of attempted access to the speakers (e.g. that the user attempted to use the set of speakers as auxiliary speakers for a television on which the second user is authorized to observe at least some content). The administrator may be automatically notified without user input after the attempted device access by a coordinating CE device via one or more of e.g. a notification on another CE device on the network being used by the administrator, email, text message, etc.

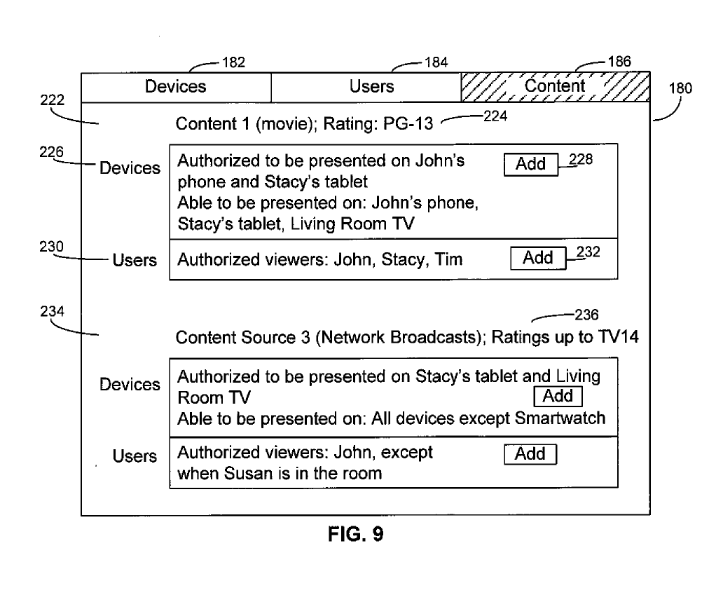

Last before moving on to FIG. 9, note that the content information 220 includes an indication that the second user through the second user profile is authorized to observe content of ratings G and PG only.

Reference is now made to FIG. 9, which again shows the UI 180 but this time with the tab 186 being the currently selected and/or operative tab. Thus, a content information portion 222 is shown when tab 186 is selected and is understood to pertain to AV content that is available from e.g. a coordinating device when a request is received thereat from another device or generated at the coordinating device itself. As shown in FIG. 9, the portion 222 is organized by content, and includes device information 226 beginning with a heading 224 for a first piece of content (labeled “Content 1”). The heading 224 also indicates the content type, which in the present instance is a movie, as well as a rating assigned to the content (e.g. by the content provider, and/or an administrator of the presently described ecosystem).

Beneath the heading 224 is device information for devices authorized and/or able to present the first content. The information 226 includes an indication of one or more devices authorized to observe the first content based on e.g. user profile configurations and/or device configurations as discussed herein. Additionally, an added/delete selector element 228 is included with the information 226 that is selectable to cause e.g. another UI to be presented for adding devices to be authorized to present the first content and/or removing devices authorized to present the first content. The information 226 also includes an indication of one or more devices that are able (e.g. based on device configurations, device parameters such as screen size, Wi-Fi connection speed, etc.) to present the first content even if not currently authorized to do so.

The portion 222 also includes user information 230 for the first content, at least including users authorized to observe the first content based on their respective user profile settings. The information 230 is accompanied by an add/delete selector element 232 that is selectable to cause e.g. another UI to be presented for adding users to be authorized to observe the first content and/or removing users authorized to observe the first content.

In addition to presenting information for the first content described above, the portion 222 may also present information not only for a particular piece of content but for a content provider and/or channel as well. In the present exemplary instance, information 234 is presented for a network broadcaster that, as indicated in heading 236, generally presents content rated TV-14 and below (e.g. less restricted content such as content for viewers of all ages). Note that in addition to the other information shown in information 234, the information 234 may include an indication that users authorized to observe content from the content source include the user John, except that John is not authorized to observe content from the content provider when another person named Susan is present as determined e.g. using facial recognition technology based on an image gathered by a camera of the CE device that identifies Susan as being present. This profile restriction may be configured by e.g. an administrator and may even be specific to Susan as opposed to John in that e.g. the administrator may configure the coordinating device to not allow presentation of content from the present content provider anytime Susan is present.

In collective reference to FIGS. 7-9, it is to be understood that information presented on the UI 180 in accordance with present principles may in some embodiments dynamically change based on a number of factors such as e.g. which user (e.g. associated with a user profile) is observing it and manipulating it, which may be done based on e.g. facial recognition in accordance with present principles that identifies a user and hence a user profile to which the UI 180 should conform. Thus, for instance, an administrator may entirely hide information (or otherwise not present the information) pertaining to a particular piece of content from being observed by a particular user in addition to not authorizing the user to observe the associated content itself. Similarly, a listing of content available over the establishment's network may only include contents the user is authorized to view per the user's profile and may omit any content the user is not authorized to view. As another example, information for devices authorized for use by one or more users and/or for presentation of particular pieces of content may dynamically change as devices join or leave an establishment's network so that the UI 180 only presents device information for devices currently communicating over and/or connected to the network.

Without reference to any particular figure, it is to be understood that a settings UI may also be presented in accordance with present principles on a coordinating CE device or any other CE device described herein to adjust settings and configurations for devices, user profiles and/or content as discussed herein. Also without reference to any particular figure, it is to be understood that the UIs, messages, prompts, etc. described herein may be configured for and presented on a coordinating CE device as discussed above and/or any other device described herein=that is e.g. connected to the same network as the coordinating device (e.g. simultaneously whenever presented on the other device), and further note that the coordinating device may provide the UI to the other device. However, note that a server operating a cloud environment for the establishment may similarly provide the ills, messages, and/or prompts described herein in some embodiments.

Also without reference to any figure, note that devices connected to an establishment's network in accordance with present principles may be represented on e.g. an establishment network and/or device map (e.g. a topographical map or topological map) that includes a representation of the establishment along with respective representations of CE devices and accompanying brief summaries of information for each device adjacent to the device representation and pertaining to the device such as e.g. the content ratings authorized for the device and/or users authorized to use the device. Such a map may have interactive functionality in that when presented on a CE device a user may e.g. drag and drop representations of devices onto particular locations of the establishment represented on the map (e.g. a particular room of a house as represented on the map) to associate the device with that location e.g. within the residence (e.g. an authorize the device for use in that location), drag and drop representations of devices onto representations of particular pieces content to e.g. designate and/or authorize the dragged and dropped content to only be presented on the device and/or device location (or at least in the location and/or on the device), and/or drag and drop representations of devices onto a representation of a particular user profile to associate a device and profile.

Furthermore, using a representation of such a map, a user may also e.g. drag and drop representations of user profiles of users (e.g. that were initially vertically lined up on the UI outside the representation of the establishment such as along a vertical edge of the display screen) onto representations of devices (to thereby associate the user profile with the device), drag and drop representations of user profiles onto representations of content (to thereby e.g. automatically authorize presentation of content on an ecosystem CE device when requested by a user associated with the dragged and dropped profile), and/or drag and drop representations of user profile onto map locations themselves to thereby associate the user profile with the location.

Similarly, representations of content may be dragged and dropped on the map to associate the content with a particular location, device, and/or user profile to thereby e.g. automatically authorize the content for and/or associate the content with being presented on the respective location, device, and/or user profile on which it was dropped.

Note that dragging and dropping on a map in accordance with present principles may also or instead be used to e.g. drag and drop representations of user profiles onto a device to thereby configure the dropped-to device to automatically without further user input store the user profile locally thereon, to drag and drop a representation of a first device onto a second device to thereby automatically without further user input configure the dropped-to second device to store device configuration information for the first device locally thereon, and/or drag and drop a representation of a piece of AV content onto a device to thereby configure automatically without further user input the AV content to be stored on the dropped-to device.

Describing content recommendations in accordance with present principles further, note that not only may content be recommended but particular devices on which the content may be presented may be recommended on one or more of the UIs described above. Thus, for instance, should high definition (HD) content be selected for viewing and despite the HD content being authorized for presentation on both e.g. a tablet computer and HD television, a CE device in accordance with present principles may recommend and/or in a single particular instance establish the HD TV as the primary, preferred, and/or recommended device on which the HD content should be presented given the HD TV's ability to best present the content (e.g., in 1080p HD) relative to other authorized devices that are available for presenting the HD content.

Further describing user profile configurations, note that a profile may be configured based on bandwidth considerations as well. For instance, a profile may be configured such that a user when viewing any content may only be permitted to use a certain percentage or amount of total establishment network bandwidth at any given time, and/or over the course of a predefined period of time.

It may now be appreciated that a digital ecosystem of CE devices is disclosed for adding, subtracting, and tracking devices within an establishment such as a home, dwelling, or personal residence. Such devices may be e.g. associated with particular user profiles, pieces of content, and/or services, and may even have content recommended to users through the devices in a format and/or configuration suitable for presentation of the content on the particular device to which it is being provided. Thus, present principles provide organization, structure, and reporting ability on devices, users and their network profiles, and/or content in a user-friendly, intuitive way. What's more, features may be added to a device and/or user profile as well, such as including a GPS tracking application on the smart phone of a child.

Further, present principles provide a “generation” of household electronic user profiles that can be locked or opened to specific devices and/or content, provide a single location (e.g. at the “coordinating CE devices” described herein) for storing all profile information, household device information, and/or content assets and/or content services, provide e.g. a one-time log in to all content services (e.g., facial recognition being seamlessly used relative to the user thereafter) so that a user does not have to re-enter service log-in information at each device and/or every time content is desired to be viewed, and provide a one-stop location (e.g. at the “coordinating CE devices” described herein and/or any other CE devices described herein) to access all content from any device a user would want, save of course any restrictions placed on the user's profile by e.g. a network administrator.

In reference to the user profiles disclosed herein, it is to be understood that a user may be associated with more than one profile, and/or may be associated with a group profile as well. For instance, a user may have first and second individual profiles. The first profile may be configured for use when the user is alone, with a specific person, and/or not with a specific person, while the second profile may be configured for use when the user is with another person such as the user's child. Thus, when a device determines e.g. based on facial recognition that the child is with the user having two profiles and submitting a request for e.g. AV content, the digital ecosystem described herein may determine that the rules, parameters, configurations, authorizations, etc. of the second profile should be used rather than those of the first profile. These two profiles may thus vary in e.g. the content that is recommended, the content ratings for content that is authorized for presentation, etc.

Returning to the use of GPS coordinates in accordance with present principles (e.g. using GPS receivers on the respective devices as described in reference to FIG. 1), note that GPS coordinates for a device may be used as a login to the digital ecosystems described herein e.g. after an initial login and/or authentication, and/or configuration of a user profile for the user of the particular device. Thus, for instance, a user may access the digital ecosystem through a living room television based on facial recognition and/or also in some embodiments based on a determination that GPS coordinates that have been provided to a coordinating device were provided by a smart phone associated with the user as being the user's e.g. primary device from a location within the establishment including the digital ecosystem.

Furthermore, in addition to using facial or fingerprint recognition to determine which profile configurations should be applied to a particular request, GPS coordinates may also be used to determine e.g. whom requested a particular piece of content be presented. For instance, should a user use a TV remote control to submit a content presentation request, it may be determined that GPS coordinates for a user's smart phone are within a predefined radius of the remote control and hence it may be determined based thereon that the user associated with the smart phone is the user submitting the request, and hence that user's profile should be applied.

Generally in reference to the digital ecosystems described herein, it is to be understood that such a digital ecosystem may be “dynamic” in that it may expand or contract based on a particular user profile and/or configurations to be applied. Hence, a digital ecosystem including the same devices, content, and/or user profiles may have different instances concurrently operating in parallel for different users. For instance, profile configurations for a child may be applied in an upstairs bedroom where the child is watching television while profile configurations for a parent may be applied in a living room of the establishment where a parent is requesting a piece of content for presentation on a tablet computer.

Accordingly, it may now be appreciated that present principles provide an organizational tool for devices and content within a personal residence or other establishment, which in some embodiments allows users access only to certain devices and/or content based on their respective profile settings. Usage rights are thus provided on a per-user basis across one or more devices and content so that the household users are only enabled to use authorized devices and/or observe or search content authorized for them to access. Finally, it is to be understood that present principles may learn (e.g. using artificial intelligence software accessing user profiles and usage reporting) what content to suggest/recommend to a user and on which device to recommend for presentation, where the recommendations are based on determinations of what content, content types, and/or content genres a particular user likes or dislikes, and even learn when the user should be recommended a particular piece of content (e.g. news recommended in the morning, entertainment recommended during prime time viewing at 8 p.m. at night).

While the particular CONFIGURING AND CONTROLLING DIGITAL ECOSYSTEM OF DEVICES, USER PROFILES, AND CONTENT is herein shown and described in detail, it is to be understood that the subject matter which is encompassed by the present invention is limited only by the claims.

1. An apparatus, comprising:
at least one computer memory that is not a transitory signal and that comprises instructions executable by a processor:
accessing plural user profiles associated with an establishment, the user profiles being electronically stored in a single computer and each user profile being associated with a respective user affiliated with the establishment;
accessing device information stored in the computer pertaining to plural devices in the establishment;
accessing content information stored in the computer and pertaining to plural media content;
receiving a user request for first content;
based at least in part on a first user profile associated with the user request, determining, based at least in part on the content information, whether a first user associated with the first user profile is authorized to access the first content;
responsive to a determination that the first user is not authorized to access the fast content, denying the request for first content;
responsive to a determination that the first user is authorized to access the first content, determining, based at least in part on the user profile and/or device information, a first device that the first user is authorized to use and that can present the first content, and returning a control signal indicating that the first user can use the first device to play the first content.

2. The apparatus of claim 1, wherein the instructions are executable to establish the control signal by automatically presenting the first content on the first device responsive to the determination that the first user is authorized to access the first content.

3. The apparatus of claim 1, wherein the instructions are executable to establish the control signal by automatically presenting a message on the first device that the first device can play the first content for the user, the message not being the first content.

4. The apparatus of claim 1, wherein the request for first content is from a second device, and the instructions are executable to establish the control signal by presenting a message on the second device to use the first device to play the content.

5. The apparatus of claim 1, wherein the establishment is a dwelling.

6. The apparatus of claim 1, comprising the processor.

7. The apparatus of claim 1, wherein the processor is not part of the computer and communicates with the computer over a network.

8. A method, comprising:
accessing plural user profiles associated with an establishment, each user profile being associated with a respective user affiliated with the establishment;
accessing device information pertaining to plural devices in the establishment;
accessing content information pertaining to plural media content;
receiving a user request for first content;
based at least in part on a first user profile associated with the user request determining, based at least in part on the content information, whether a first user associated with the first user profile is authorized to access the first content;
responsive to a determination that the first user is not authorized to access the first content, denying the request for first content;
responsive to a determination that the first user is authorized to access the first content, determining, based at least in part on the user profile and/or device information, a first device that the first user is authorized to use and that can present the first content, and returning a control signal indicating that the first user can use the first device to play the first content.

9. The method of claim 8, comprising establishing the control signal by automatically presenting the first content on the first device responsive to the determination that the first user is authorized to access the first content.

10. The method of claim 8, comprising establishing the control signal by automatically presenting a message on the first device that the first device can play the first content for the user, the message not being the first content.

11. The method of claim 8, wherein the request for first content is received from a second device, and the method comprises establishing the control signal by presenting a message on the second device to use the first device to play the content.

12. The method of claim 8, wherein the establishment is a dwelling.

13. The method of claim 8, wherein method is executed by a single computer storing the device information, user profiles, and content information.

14. The method of claim 8, wherein the method is not executed by a single computer storing the device information, user profiles, and content information but by a device that communicates with the computer over a network.

15. A computer system, comprising:
a processor; and
a computer readable medium accessible to the processor and bearing instructions executable by the processor for:
presenting a user interface (UI) on a display controllable by the processor, the UI including at least first, second, and third selector elements, the first selector element selectable to cause information pertaining to devices configured to communicate on a network to be presented, the second selector element selectable to cause information pertaining to respective user profiles of plural users to be presented, the information pertaining to respective user profiles including information for each of the plural users indicating the user's respective profile is associated with at least one of the devices, the third selector element selectable to cause information pertaining to audio video (AV) content to be presented, the information pertaining to AV content including information for whether at least a first user is authorized to observe the AV content and on which device or devices configured to communicate on the network the first user is authorized to observe AV content.

16. The computer system of claim 15, wherein the information pertaining to devices configured to communicate on the network includes respective information for each of the devices indicating at least one respective user associated with the device.

17. The computer system of claim 15, wherein the information pertaining to devices configured to communicate on the network includes information indicating at least one AV content rating for AV content for each respective device which the respective device is authorized to present.

18. The computer system of claim 15, wherein the information pertaining to respective user profiles of plural users includes information indicating for each user profile at least one AV content rating for AV content for which the user associated with the profile is authorized to observe.

19. The computer system of claim 15, wherein the computer system if configured to provide the UI to at least a first device of the devices for presentation of the UI on the first device when the first device is connected to the network.

20. The computer system of claim 15, wherein the network is a residential Wi-Fi network.
